(19) United States
(12) Patent Application Publication
(10) Pub. No.: US 2026/0253181 A1
(43) Pub. Date: Aug. 27, 2026

(54) SYSTEM AND A METHOD FOR NOISE ARTIFACT MITIGATION IN TIME-OF-FLIGHT CAMERAS

(71) Applicant: E-CON SYSTEMS INDIA PRIVATE LIMITED, CHENNAI (IN)

(72) Inventors: Radhika S, CHENNAI (IN); Selvamani S, CHENNAI (IN)

(21) Appl. No.: 19/060,971

(22) Filed: Feb. 24, 2025

(51) Int. Cl. G06T 5/70; G06T 5/60; G06V 10/26; G06V 10/30; G06V 10/60; G06V 10/62; G06V 10/72; G06V 10/776; G06V 10/98

(52) U.S. Cl. CPC G06T 5/70; G06T 5/60; G06V 10/273; G06V 10/30; G06V 10/60; G06V 10/62; G06V 10/72; G06V 10/776; G06V 10/98; G06T 2207/10028; G06T 2207/20081; G06T 2207/20084

(57) ABSTRACT

A system and a method for noise artifact mitigation in Time-of-Flight cameras is disclosed. A receiving module receives a depth frame of an image captured by the Time-of-Flight camera. A noise artifact detection module includes an artificial intelligence module detecting one or more regions affected by noise artifacts and output corresponding to a plurality of bounding box coordinates. A noise artifact verification module verifies whether the one or more regions detected are affected by the one or more noise artifacts or represents false positives using a noise artifact identification algorithm. A depth reconstruction module removes a false depth information from the one or more regions, estimate a corrected depth information for the one or more regions and employ a statistical based depth reconstruction algorithm with a region-specific reconstruction filter to replace the false depth information to generate a final denoised depth frame.

### FIELD OF INVENTION

Embodiments of the present disclosure relate to the field image processing systems, and more particularly, a system and a method for noise artifact mitigation in time-of-flight cameras.

### BACKGROUND

A time-of-flight camera (ToF camera), also known as time-of-flight sensor (ToF sensor), is a range imaging camera system for measuring distances between the camera and the subject for each point of the image based on time-of-flight, the round-trip time of an artificial light signal, as provided by a laser or an LED. The time-of-flight measurement allows the camera to calculate the distance to each point in the scene, creating a depth map.

The ToF cameras typically use infrared (IR) sensors to detect reflected light and measure depth. The IR sensors are highly sensitive to environmental dust, airborne particles and the like, which scatter IR light. The IR sensors tend to capture these tiny particles and generate depth data for the regions surrounding them. This noise affects the depth information in the respective pixels they pass through, causing the final depth image to be significantly affected and leading to false depth information. The actual depth regions, which are vital for certain applications, are obstructed by these particles, causing blind regions.

Existing methods attempt to minimize noise artifacts by using a simple average or temporal filter. However, these methods are inefficient for several reasons, such as susceptibility to motion artifacts and inadequate noise filtering.

Hence, there is a need for an improved system and a method for noise artifact mitigation in time-of-flight cameras which address the aforementioned issue(s).

### OBJECTIVES OF THE INVENTION

The primary objective of the invention is to remove noise artifacts caused by noise artifact in images captured by Time-of-Flight (TOF) cameras.

Another objective of the invention is to introduce a noise artifact detection module that integrates an artificial intelligence model to detect the one or more regions within the depth frame affected by the noise artifacts and a noise artifact identification algorithm as a secondary verification layer to confirm whether the one or more regions detected are genuinely affected by the noise artifacts or represent misclassified objects.

Yet another objective of the invention is to output a plurality of bounding box coordinates for one or more regions within the depth frame identified as containing noise artifact.

Yet another objective of the invention is to generate a final denoised depth frame by removing false depth data caused by noise artifact, utilizing temporal data from consecutive frames and a statistical based depth reconstruction algorithm with a region-specific reconstruction filter.

### BRIEF DESCRIPTION

In accordance with an embodiment of the present disclosure, a system for noise artifact mitigation in Time-of-Flight cameras is provided. The system includes a hardware processor, and a memory coupled to the hardware processor. The memory comprises a set of program instructions in the form of a processing subsystem configured to be executed by the hardware processor. The processing subsystem is configured to control bidirectional communications among a plurality of modules. The processing subsystem includes a receiving module configured to receive a depth frame of an image captured by the Time-of-Flight camera. The depth frame comprises depth information for each pixel, distorted by noise artifact. The processing subsystem includes a noise artifact detection module operatively coupled to the receiving module. The noise artifact detection module includes an artificial intelligence module. The artificial intelligence module is configured to detect one or more regions within the depth frame affected by one or more noise artifacts caused by reflection of a plurality of dust particles using an artificial intelligence model to identify irregularities within the depth frame. Further, the artificial intelligence module is configured to output a plurality of bounding box coordinates corresponding to the one or more regions detected. The noise artifact detection module includes a noise artifact verification module operatively coupled to the artificial intelligence module. The noise artifact verification module is configured to verify whether the one or more regions detected are affected by the one or more noise artifacts or represents false positives using a noise artifact identification algorithm. The processing subsystem includes a depth reconstruction module operatively coupled to the noise artifact detection module. The depth reconstruction module is configured to remove a false depth information from the one or more regions affected by noise artifact. The depth reconstruction module is configured to estimate a corrected depth information for the one or more regions detected by utilizing temporal data of consecutive frames. The depth reconstruction module is configured to employ a statistical based depth reconstruction algorithm with a region-specific reconstruction filter to replace the false depth information with the corrected depth information to generate a final denoised depth frame.

In accordance with an embodiment of the present disclosure, a method for noise artifact mitigation in Time-of-Flight cameras is provided. The method includes receiving, by a receiving module, a depth frame of an image captured by the Time-of-Flight camera, wherein the depth frame comprises depth information for each pixel, distorted by noise artifact. The method includes detecting, by an artificial intelligence module of a noise artifact detection module, one or more regions within the depth frame affected by one or more noise artifacts caused by reflection of a plurality of dust particles using an artificial intelligence model to identify irregularities within the depth frame. The method includes outputting, by the artificial intelligence module of the noise artifact detection module, a plurality of bounding box coordinates corresponding to the one or more regions detected. The method includes verifying, by a noise artifact verification module of the noise artifact detection module, whether the one or more regions detected are affected by the one or more noise artifacts or represent false positives using a noise artifact identification algorithm. The method includes removing, by a depth reconstruction module, the false depth information from the one or more regions affected by noise artifact. The method includes estimating, by the depth reconstruction module, a corrected depth information for the one or more regions detected by utilizing a temporal data of consecutive frames. The method includes employing, by the depth reconstruction module, a statistical based depth reconstruction algorithm with a region-specific reconstruction filter to replace the false depth information with the corrected depth information to generate a final denoised depth frame.

In accordance with another embodiment of the present disclosure, a non-transitory computer-readable medium storing a computer program that, when executed by a processor, causes the processor to perform a method for noise artifact mitigation in Time-of-Flight cameras is provided. The method includes receiving, by a receiving module, a depth frame of an image captured by the Time-of-Flight camera, wherein the depth frame comprises depth information for each pixel, distorted by noise artifact. The method includes detecting, by an artificial intelligence module of a noise artifact detection module, one or more regions within the depth frame affected by one or more noise artifacts caused by reflection of a plurality of dust particles using an artificial intelligence model to identify irregularities within the depth frame. The method includes outputting, by the artificial intelligence module of the noise artifact detection module, a plurality of bounding box coordinates corresponding to the one or more regions detected. The method includes verifying, by a noise artifact verification module of the noise artifact detection module, whether the one or more regions detected are affected by the one or more noise artifacts or represent false positives using a noise artifact identification algorithm. The method includes removing, by a depth reconstruction module, a false depth information from the one or more regions affected by noise artifact. The method includes estimating, by the depth reconstruction module, a corrected depth information for the one or more regions detected by utilizing a temporal data of consecutive frames. The method includes employing, by the depth reconstruction module, a statistical based depth reconstruction algorithm with a region-specific reconstruction filter to replace the false depth information with the corrected depth information to generate a final denoised depth frame.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for noise artifact mitigation in Time-of-Flight cameras in accordance with an embodiment of the present disclosure;

FIG. 2 is a block diagram representation of an exemplary embodiment of a system for noise artifact mitigation in Time-of-Flight cameras in accordance with an embodiment of the present disclosure;

FIG. 3 is a block diagram of a computer or a server in accordance with an embodiment of the present disclosure; and

FIG. 4 illustrates a flow chart representing the steps involved in a method for noise artifact mitigation in Time-of-Flight cameras in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated computer-implemented system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for noise artifact mitigation in Time-of-Flight cameras. The system includes a hardware processor, and a memory coupled to the hardware processor. The memory comprises a set of program instructions in the form of a processing subsystem configured to be executed by the hardware processor. The processing subsystem is configured to control bidirectional communications among a plurality of modules. The processing subsystem includes a receiving module configured to receive a depth frame of an image captured by the Time-of-Flight camera. The depth frame comprises depth information for each pixel, distorted by noise artifact. The processing subsystem includes a noise artifact detection module operatively coupled to the receiving module. The noise artifact detection module includes an artificial intelligence module. The artificial intelligence module is configured to detect one or more regions within the depth frame affected by one or more noise artifacts caused by reflection of a plurality of dust particles using an artificial intelligence model to identify irregularities within the depth frame. Further, the artificial intelligence module is configured to output a plurality of bounding box coordinates corresponding to the one or more regions detected. The noise artifact detection module includes a noise artifact verification module operatively coupled to the artificial intelligence module. The noise artifact verification module is configured to verify whether the one or more regions detected are affected by the one or more noise artifacts or represents false positives using a noise artifact identification algorithm. The processing subsystem includes a depth reconstruction module operatively coupled to the noise artifact detection module. The depth reconstruction module is configured to remove a false depth information from the one or more regions affected by noise artifact. The depth reconstruction module is configured to estimate a corrected depth information for the one or more regions detected by utilizing temporal data of consecutive frames. The depth reconstruction module is configured to employ a statistical based depth reconstruction algorithm with a region-specific reconstruction filter to replace the false depth information with the corrected depth information to generate a final denoised depth frame.

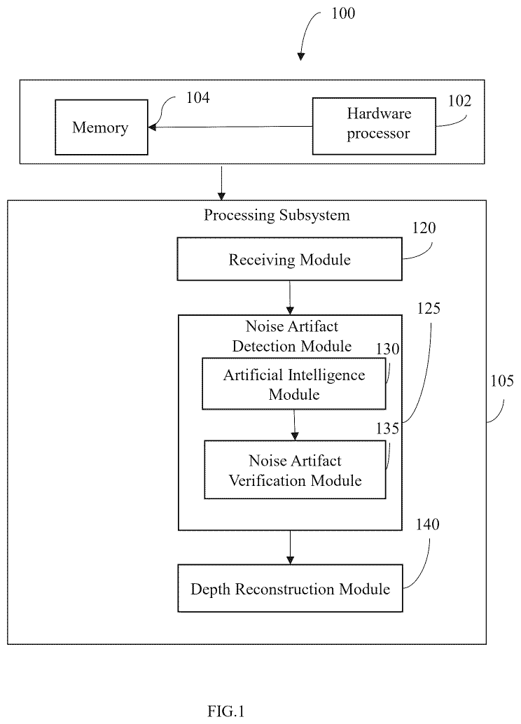

FIG. 1 is a block diagram representation of a system 100 for noise artifact mitigation in Time-of-Flight cameras in accordance with an embodiment of the present disclosure. The system 100 includes a hardware processor 102 and a memory 104 coupled to the hardware processor 102. The memory 104 includes a set of program instructions in the form of a processing subsystem 105 and configured to be executed by the hardware processor 102. As used herein, the hardware processor performs data processing, decision making, and all general computing tasks and coordinates tasks done by memory, disk storage, and other system components.

The processing subsystem 105 includes a receiving module 120 configured to receive a depth frame of an image captured by the Time-of-Flight camera. The Time-of-Flight camera also referred to as a Time-of-Flight sensor (ToF sensor), is a range imaging system designed to measure the distance between the camera and various points in a scene. It operates by calculating the round-trip time of an emitted artificial light signal, typically generated by a laser or LED, as it travels to the subject and back to the camera. The depth frame is a type of image frame that represents the distance between the camera and points in the scene. The depth frame is a collection of Z-coordinates that correspond to each pixel in an image captured by the time-of-flight camera. The depth frame includes depth information for each pixel, distorted by noise artifact.

A noise artifact detection module 125 includes an artificial intelligence module 130 detect one or more regions within the depth frame affected by one or more noise artifacts caused by reflection of a plurality of dust particles using an artificial intelligence model to identify irregularities within the depth frame. Examples of one or more noise artifacts include but are not limited to dust, smoke, fog, glare, and the like. The artificial intelligence model is trained on a dataset including a plurality of images comprising infrared images, depth images with varying levels of dust noise, and grayscale images captured in a plurality of environments. However, the system may be adapted to other datasets, including plurality of images of higher or lower resolutions to enhance versatility across diverse applications and environmental conditions.

It must be noted that the artificial intelligence model is retrained using new datasets on a regular basis to enhance the accuracy of the artificial intelligence model.

In one embodiment, the noise artifact identification algorithm may leverage additional contextual data such as the shape, size, and temporal behavior of one or more detected regions to improve classification accuracy.

It must be noted that the artificial intelligence model uses an advanced artificial intelligence algorithm. Examples of the advanced artificial intelligence algorithm include, but are not limited to, a Deep Neural Network (DNN), Convolutional Neural Network (CNN), Restricted Boltzmann Machine (RBM), Deep Belief Network (DBN) and Deep Q-Networks.

Further, the artificial intelligence module 130 is configured to output a plurality of bounding box coordinates corresponding to the one or more regions detected. The plurality of bounding box coordinates is a set of coordinated defining rectangular regions within the depth frame.

The noise artifact detection module 125 includes a noise artifact verification module 135 operatively coupled to the artificial intelligence module 130. The noise artifact verification module 135 is configured to verify whether the one or more regions detected are affected by the one or more noise artifacts or represent false positives using a noise artifact identification algorithm. The noise artifact identification algorithm functions as a secondary verification layer to confirm whether the one or more regions detected are affected by the one or more noise artifacts or represent misclassified objects, thereby reducing the occurrence of false positives. False positives refer to instances when the system mistakenly classifies an object, like a human hand or head, as a noise artifact (e.g., dust particles), leading to incorrect depth data or object detection results.

In one embodiment, the noise artifact detection module 125 utilizes a convolutional neural network.

The processing subsystem 105 includes a depth reconstruction module 140 operatively coupled to the noise artifact detection module 125. The depth reconstruction module 140 is configured to remove a false depth information from the one or more regions affected by noise artifact. The depth reconstruction module 140 is configured to estimate a corrected depth information for the one or more regions detected by utilizing temporal data of consecutive frames. The temporal data of consecutive frames refer to the information captured by the Time-of-Flight cameras from successive frames over time, enabling the system to track changes in a scene.

The depth reconstruction module 140 is configured to employ a statistical based depth reconstruction algorithm with a region-specific reconstruction filter to replace the false depth information with the corrected depth information to generate a final denoised depth frame.

The statistical based depth reconstruction algorithm uses varying levels of threshold or delta based on a predicted confidence value of the one or more regions detected by the artificial intelligence model.

It must be noted that the depth reconstruction algorithm is configured to eliminate motion artifacts during the reconstruction process. This is achieved by applying the statistical-based depth reconstruction filter only to the region affected by noise artifact rather than the entire depth frame. By isolating the reconstruction process, the system ensures that dynamic elements in the scene remain unaffected.

Let's consider an example where an Autonomous Mobile Robot (AMR) is integrated with a Time-of-Flight (ToF) camera. The ToF camera is equipped with the system 100 for noise artifact mitigation, particularly in environments with dust. As the AMR operates in such a dusty environment, the ToF camera captures depth frames to measure distances between the AMR and an object. The receiving module 120 receives the depth frames. The noise artifact detection module 125 analyzes the depth frame to detect one or more regions within the depth frame affected by one or more noise artifacts using the artificial intelligence model. These regions are marked with the plurality of bounding box coordinates, indicating potential noise artifacts. Next, the noise artifact verification module 135 verifies the identified regions using a noise artifact identification algorithm, confirming whether they are actual noise artifacts or false positives (e.g., objects mistakenly identified as dust). Once verified, the depth reconstruction module 140 applies a statistical-based algorithm to correct the false depth data using temporal information from consecutive frames. By focusing the reconstruction process only on the regions affected by dust. The result is a final, denoised depth frame that ensures precise distance measurements, enabling the AMR to operate in dusty environments.

In one embodiment, the various functional components of the computer-implemented system may reside on a single computer, or they may be distributed across several computers in various arrangements. The various components of the computer-implemented system may, furthermore, access one or more databases, and each of the various components of the computer-implemented system may be in communication with one another. Further, while the components of FIG. 1 are discussed in the singular sense, it will be appreciated that in other embodiments multiple instances of the components may be employed.

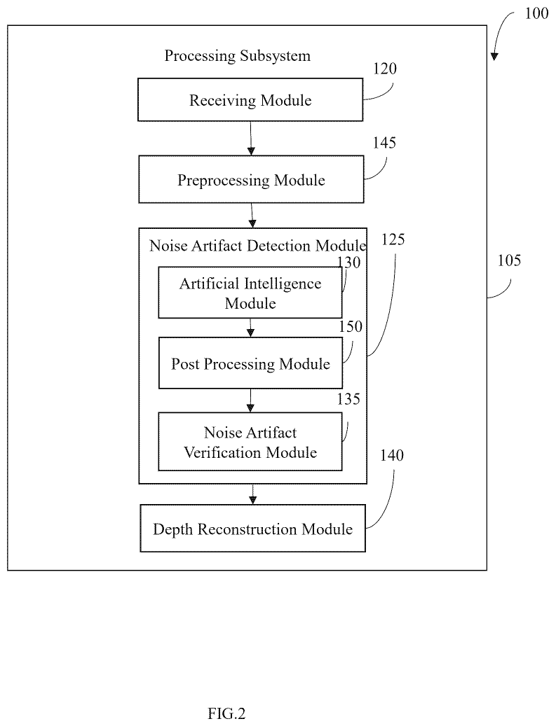

FIG. 2 is a block diagram representation of an exemplary embodiment of a system for noise artifact mitigation in Time-of-Flight cameras in accordance with an embodiment of the present disclosure. The system 100 includes the processing subsystem 105 further has following modules: a receiving module 120, a noise artifact detection module 125, and a depth reconstruction module 140. Further, the processing subsystem 105 includes a preprocessing module 145 operatively coupled to the receiving module 120, wherein the preprocessing module 145 is configured to enhance the quality of the depth frame by performing noise reduction, and image resizing. The depth frames that are preprocessed are moved to further processing by the noise artifact detection module 125. Additionally, the noise artifact detection module 125 further comprises a post processing module 150 operatively coupled to the artificial intelligence module 130. The post processing module 150 is configured to utilize the plurality of bounding box coordinates obtained from the artificial intelligence model 130 to perform the secondary noise artifact verification and reconstruction by selectively applying statistical temporal correction.

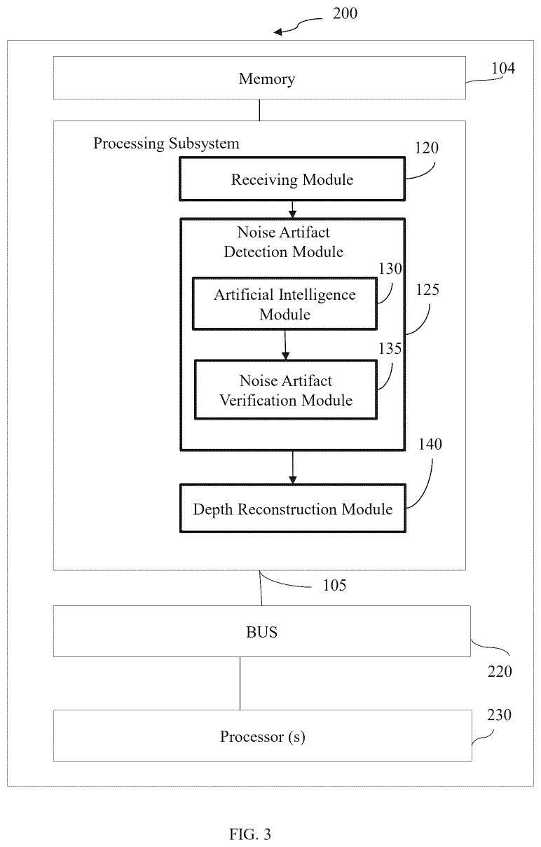

FIG. 3 is a block diagram of a computer 200 in accordance with an embodiment of the present disclosure. The server 200 includes processor(s) 230, and memory 104 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The server 200 includes several subsystems that are responsible for executing specific operations. The several subsystems are stored in the form of executable program in memory 104 and are fetched as required by the processor 230 to perform the method steps illustrated in FIG. 1. The server 200 includes a processing subsystem 105 of FIG. 1, which is a part of the processor 230. The processing subsystem 105 further has following modules: a receiving module 120, a noise artifact detection module 125, and a depth reconstruction module 140.

In accordance with an embodiment of the present disclosure, a system 100 for noise artifact mitigation in Time-of-Flight cameras is provided. The system 100 includes a hardware processor, and a memory coupled to the hardware processor. The memory comprises a set of program instructions in the form of a processing subsystem 105 configured to control bidirectional communications among a plurality of modules. The processing subsystem 105 includes a receiving module 120 configured to receive a depth frame of an image captured by the Time-of-Flight camera. The depth frame comprises depth information for each pixel, distorted by noise artifact. The processing subsystem 105 includes a noise artifact detection module 125 operatively coupled to the receiving module 120. The noise artifact detection module 125 includes an artificial intelligence module 130. The artificial intelligence module 130 is configured to detect one or more regions within the depth frame affected by one or more noise artifacts caused by reflection of a plurality of dust particles using an artificial intelligence model to identify irregularities within the depth frame. Further, the artificial intelligence module 130 is configured to output a plurality of bounding box coordinates corresponding to the one or more regions detected. The noise artifact detection module includes a noise artifact verification module 135 operatively coupled to the artificial intelligence module 130. The noise artifact verification module 135 is configured to verify whether the one or more regions detected are affected by the one or more noise artifacts or represent false positives using a noise artifact identification algorithm. The processing subsystem 105 includes a depth reconstruction module 140 operatively coupled to the noise artifact detection module. The depth reconstruction module 140 is configured to remove a false depth information from the one or more regions affected by noise artifact. The depth reconstruction module 140 is configured to estimate a corrected depth information for the one or more regions detected by utilizing temporal data of consecutive frames. The depth reconstruction module 140 is configured to employ a statistical based depth reconstruction algorithm with a region-specific reconstruction filter to replace the false depth information with the corrected depth information to generate a final denoised depth frame.

While computer-readable medium is shown in an example embodiment to be a single medium, the term “computer-readable medium” should be taken to include a single medium or multiple media (for example, a centralized or distributed database, or associated caches and servers) able to store the instructions. The term “computer readable medium” shall also be taken to include any medium that is capable of storing instructions for execution by the machine and that cause the machine to perform any one or more of the methodologies disclosed herein. The term “computer-readable medium” includes, but not to be limited to, data repositories in the form of solid-state memories, optical media, and magnetic media.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein may include but not limited to, a system bus, an internal bus, an external bus, an expansion bus, a frontside bus, a backside bus, and the like.

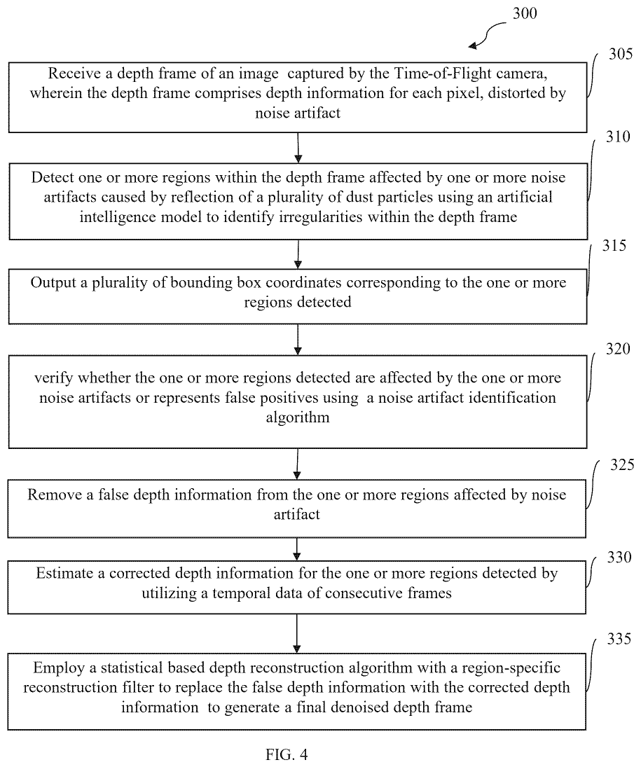

FIG. 4 illustrates a flow chart representing the steps involved in a method 300 for noise artifact mitigation in Time-of-Flight cameras in accordance with an embodiment of the present disclosure. The method 300 begins at step 305.

At step 305, the method 300 includes receiving, by a receiving module, a depth frame of an image captured by the Time-of-Flight camera. The Time-of-Flight camera also referred to as a Time-of-Flight sensor (ToF sensor), is a range imaging system designed to measure the distance between the camera and various points in a scene. It operates by calculating the round-trip time of an emitted artificial light signal, typically generated by a laser or LED, as it travels to the subject and back to the camera. The depth frame is a type of image frame that represents the distance between the camera and points in the scene. The depth frame is a collection of Z-coordinates that correspond to each pixel in an image captured by the time-of-flight camera. The depth frame comprises depth information for each pixel, distorted by noise artifact.

At step 310, the method 300 includes detecting, by an artificial intelligence module of a noise artifact detection module, one or more regions within the depth frame affected by one or more noise artifacts caused by reflection of a plurality of dust particles using an artificial intelligence model to identify irregularities within the depth frame. Examples of one or more noise artifacts include but not limited to dust, smoke, fog, glare and the like. The artificial intelligence model is trained on a dataset including a plurality of images comprising infrared images, depth images with varying levels of noise artifact, and grayscale images captured in a plurality of environments. However, the system may be adapted to other datasets, including plurality of images of higher or lower resolutions to enhance versatility across diverse applications and environmental conditions.

It must be noted that the artificial intelligence model is retrained using new datasets on a regular basis to enhance the accuracy of the artificial intelligence model.

At step 315, the method 300 includes outputting, by the artificial intelligence module of the noise artifact detection module, a plurality of bounding box coordinates corresponding to the one or more regions detected. The plurality of bounding box coordinates is a set of coordinated defining rectangular regions within the depth frame.

At step 320, the method 300 includes verifying, by a noise artifact verification module of the noise artifact detection module, whether the one or more regions detected are affected by the one or more noise artifacts or represents false positives using a noise artifact identification algorithm. The noise artifact identification algorithm functions as a secondary verification layer to confirm whether the one or more regions detected are affected by the one or more noise artifacts or represents misclassified objects, thereby reducing occurrence of false positives. False positives refer to instances when the system mistakenly classifies an object, like a human hand or head, as a noise artifact (e.g., dust particles), leading to incorrect depth data or object detection results.

At step 325, the method 300 includes removing, by a depth reconstruction module, a false depth information from the one or more regions affected by noise artifact.

At step 330, the method 300 includes estimating, by the depth reconstruction module, a corrected depth information for the one or more regions detected by utilizing a temporal data of consecutive frames.

At step 335, the method 300 includes employing, by the depth reconstruction module, a statistical based depth reconstruction algorithm with a region-specific reconstruction filter to replace the false depth information with the corrected depth information to generate a final denoised depth frame.

The statistical based depth reconstruction algorithm uses varying levels of threshold or delta based on a predicted confidence value of the one or more regions detected by the artificial intelligence model.

It must be noted that, the depth reconstruction algorithm is configured to eliminate motion artifacts during the reconstruction process. This is achieved by applying the statistical-based depth reconstruction filter only to the region affected by noise artifact rather than the entire depth frame. By isolating the reconstruction process, the system ensures that dynamic elements in the scene remain unaffected.

Various embodiments of the system and the method for noise artifact mitigation in Time-of-Flight cameras provides several benefits. The system removes noise artifacts caused by noise artifacts in images captured by Time-of-Flight (TOF) cameras, thereby improving the accuracy of depth measurements of the Time-of-Flight (TOF) cameras. Further, the use of artificial intelligence model in the noise artifact detection module minimizes false positives, ensuring precise detection of noise-affected regions.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for noise artifact mitigation in Time-of-Flight cameras comprising:
a hardware processor; and
a memory coupled to the hardware processor, wherein the memory comprises a set of program instructions in the form of a processing subsystem, configured to be executed by the hardware processor, wherein the processing subsystem is configured to control bidirectional communications among a plurality of modules comprising:
a receiving module configured to receive a depth frame of an image captured by the Time-of-Flight camera, wherein the depth frame comprises depth information for each pixel, distorted by noise artifact;
a noise artifact detection module operatively coupled to the receiving module, comprising:
an artificial intelligence module configured to:
detect one or more regions within the depth frame affected by one or more noise artifacts caused by reflection of a plurality of dust particles using an artificial intelligence model to identify irregularities within the depth frame; and
output a plurality of bounding box coordinates corresponding to the one or more regions detected;
a noise artifact verification module operatively coupled to the artificial intelligence module, wherein the noise artifact verification module is configured to verify whether the one or more regions detected are affected by the one or more noise artifacts or represents false positives using a noise artifact identification algorithm;
a depth reconstruction module operatively coupled to the noise artifact detection module, wherein the depth reconstruction module is configured to:
remove a false depth information from the one or more regions affected by noise artifact;
estimate a corrected depth information for the one or more regions detected by utilizing a temporal data of consecutive frames;
employ a statistical based depth reconstruction algorithm with a region-specific reconstruction filter to replace the false depth information with the corrected depth information to generate a final denoised depth frame.

2. The system of claim 1, wherein the depth frame is a collection of Z-coordinates that correspond to each pixel in an image captured by the time-of-flight camera.

3. The system of claim 1, wherein the artificial intelligence model is trained on a dataset comprising a plurality of images comprising infrared images, depth images with varying levels of noise artifact, and grayscale images captured in a plurality of environments.

4. The system of claim 1, further comprises a preprocessing module operatively coupled to the receiving module, wherein the preprocessing module is configured to enhance the quality of the depth frame by performing noise reduction, and image resizing.

5. The system of claim 1, wherein the noise artifact detection module further comprises a post processing module operatively coupled to the artificial intelligence module wherein the post processing module is configured to utilize the plurality of bounding box coordinates obtained from the artificial intelligence model to perform the secondary noise artifact verification and reconstruction by selectively applying statistical temporal correction.

6. The system of claim 1, wherein the one or more noise artifacts comprise dust, smoke, glare and fog.

7. The system of claim 1, wherein the plurality of bounding box coordinates is a set of coordinated defining rectangular regions within the depth frame.

8. The system of claim 1, wherein the temporal data of consecutive frames comprises consecutive depth frames captured by the Time-of-Flight camera.

9. The system of claim 1, wherein the statistical based depth reconstruction algorithm uses varying levels of threshold or delta based on a predicted confidence value of the one or more regions detected by the artificial intelligence model.

10. The system of claim 1, wherein, the noise artifact detection module utilizes a convolutional neural network.

11. The system of claim 1, wherein the artificial intelligence model is retrained using new datasets on a regular basis to enhance the accuracy of the artificial intelligence model.

12. A method for noise artifact mitigation in Time-of-Flight cameras comprising:
receiving, by a receiving module, a depth frame of an image captured by the Time-of-Flight camera, wherein the depth frame comprises depth information for each pixel, distorted by noise artifact;
detecting, by an artificial intelligence module of a noise artifact detection module, one or more regions within the depth frame affected by one or more noise artifacts caused by reflection of a plurality of dust particles using an artificial intelligence model to identify irregularities within the depth frame;
outputting, by the artificial intelligence module of the noise artifact detection module, a plurality of bounding box coordinates corresponding to the one or more regions detected;
verifying, by a noise artifact verification module of the noise artifact detection module, whether the one or more regions detected are affected by the one or more noise artifacts or represents false positives using a noise artifact identification algorithm;
removing, by a depth reconstruction module, a false depth information from the one or more regions affected by noise artifact;
estimating, by the depth reconstruction module, a corrected depth information for the one or more regions detected by utilizing a temporal data of consecutive frames; and
employing, by the depth reconstruction module, a statistical based depth reconstruction algorithm with a region-specific reconstruction filter to replace the false depth information with the corrected depth information to generate a final denoised depth frame.

13. A non-transitory computer-readable medium storing a computer program that, when executed by a processor, causes the processor to perform a method for noise artifact mitigation in Time-of-Flight cameras comprising:
receiving, by a receiving module, a depth frame of an image captured by the Time-of-Flight camera, wherein the depth frame comprises depth information for each pixel, distorted by noise artifact;
detecting, by an artificial intelligence module of a noise artifact detection module, one or more regions within the depth frame affected by one or more noise artifacts caused by reflection of a plurality of dust particles using an artificial intelligence model to identify irregularities within the depth frame;
outputting, by the artificial intelligence module of the noise artifact detection module, a plurality of bounding box coordinates corresponding to the one or more regions detected;
verifying, by a noise artifact verification module of the noise artifact detection module, whether the one or more regions detected are affected by the one or more noise artifacts or represents false positives using a noise artifact identification algorithm;
removing, by a depth reconstruction module, a false depth information from the one or more regions affected by noise artifact;
estimating, by the depth reconstruction module, a corrected depth information for the one or more regions detected by utilizing a temporal data of consecutive frames; and
employing, by the depth reconstruction module, a statistical based depth reconstruction algorithm with a region-specific reconstruction filter to replace the false depth information with the corrected depth information to generate a final denoised depth frame.
